(19) United States
(12) Patent Application Publication
(10) Pub. No.: US 2016/0325372 A1
(43) Pub. Date: Nov. 10, 2016

(54) LOW HEAT INPUT WELD REPAIR OF CAST IRON

(71) Applicant: CATERPILLAR INC., PEORIA, IL (US)

(72) Inventors: Dale Clifford GRIGORENKO, Iuka, MS (US); Christopher Anthony KINNEY, Iuka, MS (US)

(73) Assignee: CATERPILLAR INC., PEORIA, IL (US)

(21) Appl. No.: 14/704,364

(22) Filed: May 5, 2015

(51) Int. Cl. B23K 9/04; B23K 9/173; B23K 9/29; C22C 19/03; B23K 9/095; B23K 35/02; B23K 35/30; B23K 9/23; B23K 9/09

(52) U.S. Cl. CPC B23K 9/044; B23K 9/23; B23K 9/173; B23K 9/295; B23K 9/09; B23K 9/095; B23K 35/0261; B23K 35/3033; C22C 19/03

(57) ABSTRACT

A method of repairing a cast iron component is disclosed. The method may include removing a damaged or defective portion of the cast iron component, and pre-heating the cast iron component to a temperature in a range from 200-800 degrees F. After pre-heating, the method may include welding a removed area of the cast iron component using a Cold Metal Transfer (CMT) process with a consumable wire electrode made from one of a carbon steel alloy, a nickel alloy, or a nickel-iron alloy material having a Coefficient of Thermal Expansion (CTE) that is within ±10% of a CTE of the cast iron material of the cast iron component to fill the area where the damaged or defective portion was removed. After welding, the cast iron component may be cooled and the welded portion of the cast iron component may be final machined.

### TECHNICAL FIELD

The present disclosure relates generally to low heat input weld repair, and more particularly, to low heat input weld repair of cast iron components.

### BACKGROUND

Components such as a turbocharger housing, an engine block, and a cylinder head for an internal combustion engine are often fabricated from cast iron. An engine block generally includes one or more combustion chambers that house a combustion process to produce mechanical work and a flow of exhaust. Each combustion chamber is formed from a cylinder, the top surface of a piston, and the bottom surface of a cylinder head. The cylinder head is typically fabricated from an iron casting or an aluminum casting having cast-in-place cast iron inserts. Grey cast iron is often the material used in the cylinder head casting. The efficiency and power of an internal combustion engine may be improved through the use of a turbocharger driven by exhaust gases produced in the combustion chambers, and fluidly connected to provide compressed air to a fuel-air mixture that is burned in the combustion chambers of the engine. Components that require significantly higher tensile strength than can be provided by grey cast iron may be fabricated from ductile cast iron. Ductile cast iron is often the material used in fabricating turbocharger housings.

During operation of a turbocharger, the cast iron housing is exposed to high cycling pressures and temperatures that may generate stresses and cause deterioration of the housing. During engine operation, the cast iron cylinder head or cylinder head inserts are also exposed to high pressures and temperatures. Over time, these high pressures and temperatures can cause deterioration of the surfaces, flanges, and ports of the turbocharger housing, the cylinder head's bottom surface, valve seat pockets, exhaust ports, and other portions of the cylinder head. As engine manufacturers are continually urged to increase fuel economy, meet lower emission regulations, and provide greater power densities, the pressures and temperatures imposed upon turbocharger housings, cylinder heads, and other engine components have been increasing. The increased temperatures and pressures may result in damage to cast iron components, and a need for improved methods of repairing the cast iron components.

One method for repairing cast iron components such as cylinder heads is disclosed in U.S. Pat. No. 7,047,612 (the '612 patent) issued to Bridges et al. on May 23, 2006. The '612 patent describes a method of repairing a casting by pouring melted filler material into a damaged portion of the original casting. A damaged cast component such as a cylinder head is pre-heated to a first pre-heat temperature. The damaged area of the casting is then heated to a higher temperature using a torch, and melted filler material is poured into the casting. Plugs of heat resistant material are used to prevent molten filler material from entering original features of the cylinder head such as exhaust and intake valve openings, and fuel injector bores. Dams are also positioned on the surface being repaired to form a riser of the filler material.

Although the method of the '612 patent may provide an expedited procedure for repairing a casting that does not require manual welding, the damaged component must still be carefully pre-heated as much as possible without damaging the component in order to avoid cracking the parent material when the molten filler material is poured onto the component. Additional heating with a torch when the molten filler material is introduced may also be required in order to ensure that the area being repaired is hot enough to permit bonding of the parent and filler materials, but cool enough to prevent the filler material from melting through the parent material. The method of the '612 patent may therefore increase the difficulty of maintaining proper temperature control to avoid the formation of bubbles or other defects during the repair process. The high carbon content of cast irons may also pose challenges as a result of metallurgical changes that occur during the welding process, and particularly when the cast iron is subjected to high temperatures and then cooled too rapidly.

The disclosed method for low heat input weld repair of cast iron components is directed to overcoming one or more of the problems set forth above and/or other shortcomings in existing technologies.

### SUMMARY

In one aspect, the present disclosure is directed to a method of weld repairing a cast iron component. The method may include removing a damaged or defective portion of the cast iron component and pre-heating the cast iron component to a temperature in a range from 200-800 degrees F. The method may further include welding a removed area of the cast iron component using a Cold Metal Transfer (CMT) process with a consumable wire electrode made from one of a carbon steel alloy, a nickel alloy, or a nickel-iron alloy material having a Coefficient of Thermal Expansion (CTE) that is within ±10% of a CTE of the cast iron material of the cast iron component to fill the area where the damaged or defective portion was removed. The method may still further include cooling the welded cast iron component and final machining the welded portion of the cast iron component.

In another aspect, the present disclosure is directed to a method of low heat input weld repairing a cast iron component. The method may include welding an area of a cast iron component using a Cold Metal Transfer (CMT) process. The CMT process may include providing electrical power from a power source to a consumable wire electrode, wherein the consumable wire electrode is made from one of a carbon steel alloy, a nickel alloy, or a nickel-iron alloy having a Coefficient of Thermal Expansion (CTE) that is within ±10% of the CTE of the cast iron material of the cast iron component. The electrical power may be provided in a succession of pulses of electrical power with varying current and/or voltage. The method may further include reciprocating the consumable wire electrode toward and away from the cast iron component, and controlling the electrical power being provided to the electrode while the electrode is being reciprocated such that at least one of a welding current and a welding voltage supplied to the electrode is pulsed from a higher value during an electric-arc phase to a lower value during a short-circuit phase. The method may still further include sensing a short-circuit condition when a molten droplet of weld filler metal on a distal end of the electrode makes contact with a molten weld pool being formed on a surface of the cast iron component, and moving the electrode away from the cast iron component and reducing the electrical power provided to the electrode each time the short-circuit condition is sensed. Reciprocating the electrode and pulsing the electrical power provided to the electrode may be repeated in order to deposit a succession of small droplets of molten weld filler metal from the electrode onto the surface of the cast iron component.

In yet another aspect, the present disclosure is directed to a method of low heat input weld repairing a cast iron component. The method may include welding an area of the cast iron component using a Short-Circuit Gas Metal Arc Welding (GMAW-S) process. The GMAW-S process may include providing electrical power from a power source to a consumable wire electrode, wherein the consumable wire electrode is made from one of a carbon steel alloy, a nickel alloy, or a nickel-iron alloy having a Coefficient of Thermal Expansion (CTE) that is within ±10% of the CTE of the cast iron material of the cast iron component. The electrical power may be provided in a succession of pulses of electrical power with varying current and/or voltage. The method may further include reciprocating the consumable wire electrode toward and away from the cast iron component and controlling the electrical power being provided to the electrode while the electrode is being reciprocated such that at least one of a welding current and a welding voltage supplied to the electrode is pulsed between a higher value and a lower value. The method may still further include sensing a short-circuit condition when a molten droplet of weld filler metal on a distal end of the electrode makes contact with a molten weld pool being formed on a surface of the cast iron component. The electrode may be moved away from the cast iron component and the electrical power provided to the electrode may be reduced each time the short-circuit condition is sensed. Reciprocating the electrode and pulsing the electrical power provided to the electrode may be repeated in order to deposit a succession of small droplets of molten weld filler metal from the electrode onto the surface of the cast iron component.

### BRIEF DESCRIPTION OF THE DRAWINGS

FIG. 1 is an illustration of an exemplary component to be repaired in accordance with the disclosed methods; and

FIG. 2 is a flow chart describing an exemplary disclosed method for low heat input weld repairing of the component shown in FIG. 1.

### DETAILED DESCRIPTION

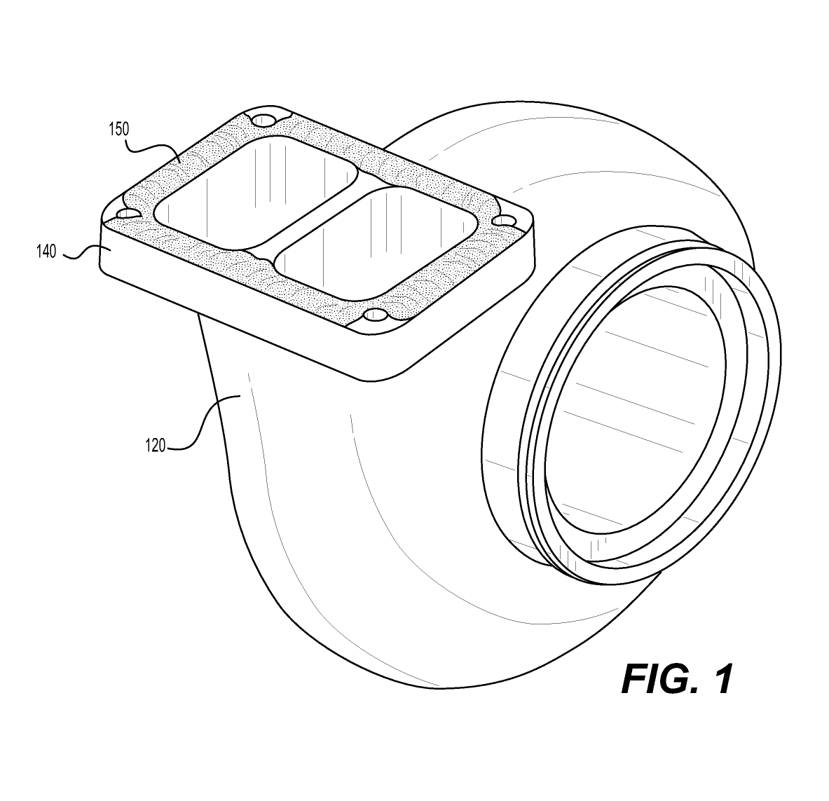

Referring to FIG. 1, an exemplary component manufactured from a material such as ductile cast iron is illustrated. In this example the component is a turbocharger housing 120. The low heat input weld repair methods disclosed herein may be used with other cast iron products that may include configurations with one or more passageways, openings, bores, and surrounding areas that may include defects such as cracks, chips, fissures, porosity, or other anomalies. The disclosed implementations may also be used for repairing other metallic components, and in particular, other cast metallic components such as components made from grey cast iron and ductile cast iron. Various grades of cast iron are used in a multitude of industrial machinery, including as housings in gearboxes of all sizes and configurations. The cast iron material provides structural rigidity and high strength, particularly in compression. Cast iron also has a good strength to weight ratio, high machinability, good corrosion resistance, good damping characteristics, and excellent castability into the many different shapes and sizes needed in various industrial applications. Grey cast iron, grade 30, for example, has a yield strength of 30,000 psi. Where greater strength is needed for more demanding applications, the chemistry and iron making processes may be adjusted to obtain ductile cast iron with yield strength that may be twice as strong as grey cast iron. In ductile cast iron the carbon takes the form of graphite in the shape of spheroids rather than as individual flakes as in gray cast iron. Ductile cast iron, sometimes referred to as nodular cast iron, may be made by inoculating the molten metal, just before casting, with a small amount of magnesium or cerium. This inoculation is what causes the free carbon in the finished casting to appear as rounded nodules of graphite rather than as flakes. The spheres of graphite don't act as stress raisers but as crack arresters, and are what give the ductile cast iron its ductility and higher yield strength. Almost every cast iron contains well over 2.0% carbon, with some containing as much as 4.0% carbon. Unlike in steel, most of the carbon in cast iron is present in uncombined form, as graphite. In steel, the carbon is combined with iron in the form of iron carbides, such as grains of pearlite, grains of cementite, or scattered small particles of carbide. Grey cast iron may also contain some combined carbon (iron carbide) as grains of pearlite, grains of cementite or martensite.

Because of their high carbon content, two problems may arise in the fusion welding of cast irons: (a) the formation of massive carbides in regions of the parent metal that are melted or partially melted during the weld pass, and (b) the formation of martensite in regions of the parent metal that are heated to a temperature above the eutectoid but below the eutectic. The eutectoid reaction is characterized by a phase transformation of one solid into two different solids. In iron-carbon (Fe-C) systems, such as in cast iron, there is a eutectoid point at approximately 723 degrees C. If the welding process heats up the base material in a fusion zone around where the weld material is being applied to temperatures above this eutectoid point, the crystal structure of the cast iron is transformed from ferrite to austenite. Subsequent cooling may result in a transformation of the austenite into cementite (iron carbide), cementite and ferrite (pearlite), and/or martensite at rapid cooling rates. The result is a fusion zone that is harder and more brittle than surrounding zones. Both carbide and martensite formation result in weld zones having properties different from those of the base metal. Thus, the weld zone may be lower in strength, lower in ductility, and more brittle than the surrounding metal.

Two approaches to the fusion welding of cast irons have been used to achieve sound welds. In the first approach, nodular graphite is produced in the weld which resembles the graphite contained in the base metal. This is accomplished by adding graphitizing agents, such as silicon, and nodularizing agents, such as magnesium or rare earth metals, to the weld metal from the welding rod or flux. In this way, a weld metal is produced which has a microstructure, mechanical properties, and thermal expansion properties similar to those of the base metal. In the second approach, nickel or copper is added as filler materials to the weld pool to produce an austenitic weld metal. The austenitic weld metal is tough, relatively soft, and exhibits other favorable properties. Satisfactory welds are produced by this approach because the eutectoid transformation to martensite is avoided and because of the ability of austenite to absorb carbon rejected by the melted cast iron, thus reducing the formation of carbides.

Nickel works successfully in the second approach discussed above because it is an austenite phase stabilizer. When present in austenite, it shifts the eutectoid point so as to suppress the transformation of austenite into pearlite. Nickel is therefore classified as an austenite former. At present, nickel is typically introduced into the weld pool as an ingredient of the welding rods. Nickel-base covered electrodes are available for the arc welding of cast irons. These electrodes are classified as “pure” nickel, containing 90 to 95% Ni, nickel-iron, containing about 55% Ni, and nickel-copper, containing about 60% Ni. The “pure” nickel and nickel-iron electrodes have emerged as the most satisfactory thus far for welding cast iron. The use of nickel as filler material for welding cast iron presents several problems. First, nickel is expensive. Second, the thermal properties of nickel are significantly different from those of cast iron and give rise to thermal expansion mismatch between base metal and weld metal. This can result in stresses high enough to cause cracking. Third, phosphorus has low solubility in nickel. This too can result in cracking when nickel-base electrodes are used to weld irons high in phosphorus.

Another problem that may be encountered when weld repairing cast irons is caused by the relatively low ductility of cast iron, and in particular grey cast iron. If grey cast iron is loaded beyond its yield point, it breaks rather than deforming to any significant extent. Therefore, the weld filler metal and part configuration generally has to be selected in order to minimize welding stresses. Because grey cast iron contains graphite in flake form, the carbon may be readily introduced into the weld pool during a weld repair process. The dilution of the base material, and particularly carbon, into the weld filler material causes weld metal embrittlement. Consequently, techniques in accordance with various implementations of the present disclosure, which minimize base metal dilution, reduce the amount of carbon formed, and reduce the Heat Affected Zone (HAZ), are desirable when weld repairing cast iron components. As grey cast iron solidifies after welding, solidification tensile stresses may result in cracking in the HAZ unless a weld filler material is used with sufficient ductility to compensate for the lack of ductility of the base material.

In accordance with various implementations of the present disclosure, variations of a Gas Metal Arc Weld (GMAW) process are used in conjunction with a consumable wire electrode made from a material with a coefficient of thermal expansion (CTE) that is within ±10% of the CTE of the base cast iron materials being weld repaired. The use of a weld material with a CTE within ±10% of the CTE of the base cast iron material ensures that there are not large differences between the amount of expansion and contraction of the base material and the weld material when the weld repaired component is exposed to large fluctuations in temperature. Large differences in the CTE between the weld material and the base metal may contribute to cracking and other defects in the weld zone after the component has undergone these fluctuations in temperature.

The variation to a GMAW process in accordance with various implementations of this disclosure is referred to herein as a Cold Metal Transfer (CMT) process. The CMT process is a modified GMAW process that uses a method of molten metal droplet detachment from the consumable wire electrode based on short-circuit welding. The CMT process is a variation to the Short-Circuit Gas Metal Arc Welding (GMAW-S) that includes controlling the amount of welding current and/or welding voltage applied to the consumable electrode, and also controlling a reciprocating movement of the electrode toward and away from the component being welded. The CMT process is characterized by reductions in the amount of heat input at the weld zone, which in turn results in a much smaller Heat Affected Zone (HAZ), less dilution of the base cast iron metal into the filler metal, and less formation of brittle martensite or pearlite microstructures in the weld zone. Less heat input during the welding process also means that the component does not have to be preheated to as high a temperature in order to reduce the cooling rate of the HAZ after welding. The formation of many small, individual droplets of molten metal during the CMT process provides an additional benefit in that there is a reduction in overall solification stresses as a result of the many small puddles of molten material solidifying rather than a single larger puddle. In various implementations of this disclosure, the cast iron component may only need to be preheated to a temperature in the range of 300-400 degrees F. A wider range of pre-heating temperatures between approximately 200-800 degrees F. may also be used. These preheat temperatures are low enough to avoid the formation of oxides on the surface of the cast iron component during and after the welding repair, and therefore reduce the amount of clean up required after welding.

The CMT process results in lower heat input as a result of cycling the amount of welding current being applied to the consumable electrode as the electrode is moved forward into contact with a molten weld puddle and then retracted. When the power source detects a short-circuit as a result of the molten droplet of weld filler metal on a distal end of the electrode contacting the molten weld puddle, the welding current drops and the electrode begins to retract. Retraction of the electrode helps to detach the droplet of molten weld metal from the electrode into the molten weld puddle on the cast iron component. In some implementations, after detection of a short-circuit, the weld current may also be provided with a spike in amplitude before dropping in order to further assist the separation of the droplet from the electrode. The electrode may be constantly retracted and extended at very short intervals of time, and the reciprocating motion of the electrode may be performed at a rate of 50-150 cycles per second. The precisely defined retraction of the electrode facilitates controlled droplet detachment to give a clean, virtually spatter-free material transfer from the consumable electrode to the cast iron component. The cycling of the welding current also results in significantly less total heat input during the welding process.

The turbocharger housing 120 shown in FIG. 1 may undergo a low heat input weld repair in accordance with various implementations of this disclosure in order to repair defects or damage. Defects or damage may include cracks, fissures, porosity, or other anomalies, for example, on a flange 140 at the outlet of the turbocharger, or on other surfaces of the component. Other surfaces of the component, including internal, inner diameter surfaces and external, outer diameter surfaces may develop defects or damage that may be repaired in accordance with various implementations of this disclosure. The area with a defect may be removed by various processes including machining, grinding, arc gouging, flame gouging, etc. In some alternative implementations of this disclosure, removal of an area with a defect or other anamoly may include preparation of the area using chemicals, shot peening, or other techniques to remove oils or other foreign matter on the surface. The removed area of the component that was discovered to have defects, damage, or other anamolies, may then be built up with weld material 150, as shown in FIG. 1. One of ordinary skill in the art will recognize that welding of the area with removed defects or damage may comprise building up part of the original volume of material that was removed, all of the original volume of removed material, or more than the original volume of removed material.

A furnace may also be used to preheat the turbocharger housing 120 after machining away or otherwise removing the defective or damaged portions of the flange 140. A furnace may be an electric furnace, a gas furnace, an infrared furnace, or any of other known types of furnaces capable of preheating the turbocharger housing 120 to temperatures in a range from approximately 200 degrees F. to 800 degrees F. In alternative implementations, the preheating may also be performed in a more localized fashion using a torch or other manually controlled heating device. After preheating, each housing or other component ready for weld repair may be placed in a smaller, portable weld box that is a furnace with removable, insulated lid sections. The portable weld box may be configured to be rolled into a room where a welder can access various sections of the component through openings in a wall separating the weld box from an air conditioned compartment where the welder is located. The weld box may be configured, for example, to maintain the preheated temperature of the turbocharger housing 120 as the flange 140 is accessed behind a removable lid section.

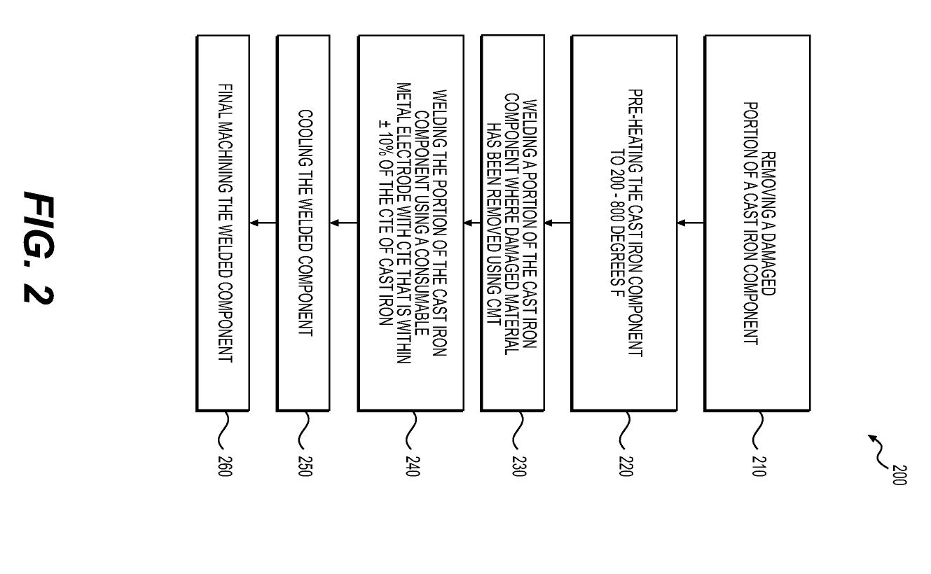

FIG. 2 illustrates an exemplary disclosed process 200 of low heat input weld repairing a cast iron component, such as a turbocharger housing. FIG. 2 will be discussed in more detail in the following section to further illustrate the disclosed concepts.

### INDUSTRIAL APPLICABILITY

The disclosed methods of low heat input weld repair of cast iron components may be applicable to a wide variety of components such as cast iron engine components, engine blocks, cylinder heads, turbocharger housings, gear box housings, or other cast iron components where the weld repair may allow for continued use of defective or damaged parts after they have been weld repaired. The disclosed methods allow for careful control of the temperatures a component reaches during the repair process, as well as significantly reducing the total heat input to components that are being repaired or bonded together in the welding process. The disclosed methods enable welding of both grey cast iron and ductile cast iron components without many of the typical problems encountered when welding cast iron. The low heat input compared to heat input generally associated with GMAW and other methods of welding cast iron results in overall distortion of the base metal of the cast iron components that is orders of magnitude less than distortion that would result from traditional welding techniques. The low heat input also results in less of a Heat Affected Zone (HAZ), and less pre-heating required before welding to reduce the cooling rate after welding for avoidance of the formation of martensite, carbides, or other brittle, crack-inducing microstructures. Less total heat input during the welding process also results in less dilution of the base metal into the weld filler metal, less depth of penetration, and less chance of developing any pockets, bubbles, or brittle, high carbon areas in the weld material that is added to build up damaged or defective areas that have been machined away. The CMT process also enables the use of more traditional carbon steel welding wire rather than requiring more expensive welding wire with high levels of nickel or manganese. This advantage stems from the CMT process producing many small puddles of molten weld material during the weld process rather than one, larger weld puddle. As a result, the overall solidification tensile stresses are reduced as the individual smaller puddles of molten metal don't exert as much solidification tensile stress on surrounding base material as would be the case with larger puddles of molten metal. The reduction in overall solidification tensile stresses means that the filler metal does not have to be as ductile a material as would otherwise be required to compensate for the relatively low ductility of the base cast iron material.

During the CMT process in accordance with various implementations of this disclosure, the consumable wire electrode is fed forwards during an electric-arc phase until the electrode comes into contact with the workpiece. During this electric-arc phase the consumable wire electrode is melted from the heat generated by the welding current flowing through the wire electrode and by the electric-arc between the distal end of the electrode and the workpiece. A droplet of molten weld filler material forms at the end of the wire electrode. During the electric-arc phase the welding current and/or the welding voltage supplied to the wire electrode may be initially controlled such that the droplet of molten metal will not detach from the distal end of the electrode. When the wire electrode with a molten droplet forming at its distal end makes contact with the weld pool formed on the workpiece, a short-circuit occurs between the electrode and the workpiece. During this short-circuit phase, the short-circuit is detected, and the wire-feed direction is reversed so that the wire electrode will be moved backwards away from the workpiece until the short circuit has been opened as a result of detachment of the droplet of molten weld filler metal from the distal end of the electrode. In some implementations of the disclosed process, the weld current may also be temporarily increased for a short period of time in order to further assist with separation of the droplet of molten metal from the distal end of the electrode. The weld current and/or voltage may be reduced after detection of the short-circuit, and for a brief period of time afterwards as the electrode is moved backwards away from the workpiece. Following this reduction in weld current and/or voltage, and after either a defined period of time or a defined distance away from the workpiece, the weld current and/or voltage may be increased again to generate another electric-arc as the electrode is again moved toward the workpiece.

During the CMT welding process, the consumable wire electrode is subjected to a reciprocating movement at a certain movement frequency corresponding to the number of short-circuits per second. The movement frequency may be, e.g., anywhere within a range from approximately 50-150 cycles per second. During each cycle a wire electrode feeding mechanism may be controlled by a first control signal that causes the electrode to be fed backwards in the short-circuit phase. After the droplet of molten metal has detached from the distal end of the electrode, the wire electrode feeding mechanism may stop the backward movement of the electrode until an increase in welding current and/or voltage results in the reigniting of an electric-arc between the electrode and the workpiece. The wire electrode feeding mechanism may then be controlled by a second control signal that causes the electrode to be fed forwards toward the workpiece in the electric-arc phase. During this electric-arc phase the electrode will be heated by both resistance to current flowing through the electrode and by heat generated from the electric-arc between the distal end of the electrode and the workpiece. The heat generated in the electrode results in the formation of a droplet of molten metal at the distal end of the electrode. However, controlling the movement direction of the consumable wire electrode does not necessarily have to correlate with the occurrence of the electric-arc phase and/or the short-circuit phase. The electric-arc phase may be effected at any point in the movement of the electrode by control of the amount of electrical energy introduced into the electrode, e.g., during the backward movement of the wire electrode. In one exemplary implementation of the process in accordance with this disclosure, an electric-arc may have already been established following the short-circuit phase, and the wire electrode may be moved away from the workpiece until a defined point of time and/or distance has been reached.

Droplet detachment from the distal end of the electrode may be effected during the electric-arc phase by movement of the wire electrode forward until the droplet makes contact with a weld pool formed on a surface of the workpiece. The surface tension of the droplet of molten filler metal on the distal end of the wire electrode once the droplet has made contact with the weld pool assists in the detachment of the droplet from the electrode during backward movement of the electrode. An increase in the welding current after a short-circuit condition has been detected may also assist with droplet detachment if the increase is timed to help pinch off the droplet from the distal end of the electrode. Re-ignition of the electric-arc during the backward movement away from the workpiece after the short-circuit phase may occur with the welding current and/or voltage initially at a reduced, base level, followed by an increase in the welding current and/or voltage as the electrode is again moved forward toward the component.

In the exemplary low heat input weld repair process 200 illustrated in FIG. 2, a damaged or defective area of a cast iron component may be removed at step 210. Various techniques for removing all traces of a defect may include chipping, grinding, arc gouging, flame gouging, chemical treatment, shot peening or other processes. Dye penetrant inspection or magnetic particle inspection are two examples of techniques that may be used to ensure that all traces of the defect have been removed. Before beginning the weld repair process, any surface oil or grease must be removed using solvents, steam cleaning, electro-chemical cleaning, abrasive blasting, or other known techniques.

The next step 220 may include pre-heating the cast iron component to within a range from approximately 200-800 degrees F. This pre-heating step may be performed in a furnace, or with localized pre-heating, such as through the use of an oxy-acetylene torch. The pre-heating step helps to ensure that the cooling rate of the HAZ after weld repair will be slow enough to avoid the generation of martensite, iron carbide, or other microstructures that are brittle and likely to lead to cracks or other defects.

After the cast iron component has been pre-heated, the exemplary process may include welding the removed area of the cast iron component using the CMT process described above (step 230). The consumable wire electrode may be reciprocated toward and away from the cast iron component while at the same time controlling the amount of welding current and/or voltage provided to the electrode. The exemplary process may include welding the removed area of the cast iron component using a consumable metal electrode having a Coefficient of Thermal Expansion (CTE) that is within ±10% of the CTE of the cast iron base material (step 240). Matching the CTE of the weld material with the CTE of the base cast iron ensures that the weld repaired area will expand and contract at approximately the same rate as the base material when the weld repaired component is subjected to temperature cycles and fluctuations during use. The welding current and/or voltage may be pulsed from a lower value immediately after a short-circuit is detected as a result of a droplet of molten metal on the distal end of the electrode contacting the weld pool on the component, to a higher value when the electric-arc phase of the CMT process resumes after the electrode is pulled away from the component, and the droplet has detached from the electrode. This cycling of the current and/or voltage applied to the electrode results in a significantly lower total amount of heat input during welding as there is a short “cooling off” period after each detection of a short-circuit and detachment of a droplet of molten weld filler metal from the distal end of the electrode. In an exemplary implementation of this disclosure, the electrode may be reciprocated toward and away from the component at anywhere from approximately 50-150 cycles per second, or even more preferably, 70-80 cycles per second. The numerous, intermittent “cooling off” periods that result help to minimize total heat input, minimize the size of the HAZ, and reduce the amount of dilution of the base metal into the filler metal.

After completion of the weld repair the welded component may be cooled off at step 250 and final machined at step 260. The pre-heating of the component before welding at step 220 helps to slow down the cooling rate of the HAZ after welding, thereby preventing the formation of martensite, iron carbides, or other microstructures that would cause brittleness and cracking in the weld repaired component.

It will be apparent to those skilled in the art that various modifications and variations can be made to the disclosed method of low heat input weld repairing of cast iron components. Other embodiments will be apparent to those skilled in the art from consideration of the specification and practice of the disclosed weld repair methods. It is intended that the specification and examples be considered as exemplary only, with a true scope being indicated by the following claims and their equivalents.

What is claimed is:

1. A method of weld repairing a cast iron component, comprising:
removing a damaged or defective portion of the cast iron component;
pre-heating the cast iron component to a temperature in a range from 200-800 degrees F.;
welding a removed area of the cast iron component using a Cold Metal Transfer (CMT) process with a consumable wire electrode made from one of a carbon steel alloy, a nickel alloy, or a nickel-iron alloy material having a Coefficient of Thermal Expansion (CTE) that is within ±10% of a CTE of the cast iron material of the cast iron component to fill the area where the damaged or defective portion was removed;
cooling the welded cast iron component; and
final machining the welded portion of the cast iron component.

2. The method of claim 1, wherein the cast iron component is pre-heated to a temperature in a range from 300-400 degrees F.

3. The method of claim 1, wherein the CMT process is a Short-Circuit Gas Metal Arc Welding (GMAW-S) process.

4. The method of claim 3, wherein the CMT process comprises pulsing at least one of a welding current and a welding voltage supplied to the consumable wire electrode.

5. The method of claim 3, wherein the CMT process comprises reciprocating the consumable wire electrode toward and away from the cast iron component.

6. The method of claim 3, wherein the CMT process comprises pulsing at least one of a welding current and a welding voltage supplied to the consumable wire electrode at the same time as reciprocating the wire electrode toward and away from the cast iron component.

7. The method of claim 6, further including:
moving the consumable wire electrode toward the cast iron component while generating an arc between a distal end of the electrode and the cast iron component by increasing at least one of the welding current and the welding voltage;
forming a droplet of molten metal on the distal end of the electrode;
detecting a short-circuit when the droplet on the distal end of the electrode contacts a weld pool on the cast iron component;
lowering the welding current after detection of the short-circuit; and
moving the consumable wire electrode away from the cast iron component, thereby assisting separation of the droplet from the distal end of the electrode.

8. The method of claim 7, wherein the consumable wire electrode is reciprocated toward and away from the cast iron component at a cycle rate of between 50 and 150 cycles per second.

9. The method of claim 7, wherein the welding current is increased immediately after detecting the short-circuit in order to assist with separation of the droplet of molten metal from the distal end of the electrode.

10. A method of low heat input weld repairing a cast iron component, the method comprising:
welding an area of a cast iron component using a Cold Metal Transfer (CMT) process, the CMT process comprising:
providing electrical power from a power source to a consumable wire electrode, wherein the consumable wire electrode is made from one of a carbon steel alloy, a nickel alloy, or a nickel-iron alloy having a Coefficient of Thermal Expansion (CTE) that is within ±10% of the CTE of the cast iron material of the cast iron component, the electrical power being provided in a succession of pulses of electrical power with varying current and/or voltage;
reciprocating the consumable wire electrode toward and away from the cast iron component;
controlling the electrical power being provided to the electrode while the electrode is being reciprocated such that at least one of a welding current and a welding voltage supplied to the electrode is pulsed from a higher value during an electric-arc phase to a lower value during a short-circuit phase;
sensing a short-circuit condition when a molten droplet of weld filler metal on a distal end of the electrode makes contact with a molten weld pool being formed on a surface of the cast iron component;
moving the electrode away from the cast iron component and reducing the electrical power provided to the electrode each time the short-circuit condition is sensed; and
repeating the reciprocating of the electrode and the pulsing of electrical power provided to the electrode in order to deposit a succession of small droplets of molten weld filler metal from the electrode onto the surface of the cast iron component.

11. The method of claim 10, further including removing material from the area of the cast iron component before welding, and pre-heating the cast iron component before commencing the CMT process to a temperature in a range from 200-800 degrees F.

12. The method of claim 10, further including pre-heating the cast iron component before commencing the CMT process to a temperature in a range from 300-400 degrees F.

13. The method of claim 10, wherein the consumable wire electrode is reciprocated toward and away from the cast iron component at a cycle rate of between 50 and 150 cycles per second.

14. The method of claim 10, further including:
moving the consumable wire electrode toward the cast iron component while generating an electric-arc between the distal end of the electrode and the cast iron component by increasing at least one of the welding current and the welding voltage;
forming the droplet of molten weld filler metal on the distal end of the electrode;
detecting the short-circuit when the droplet on the distal end of the electrode contacts the molten weld pool on the cast iron component;
increasing the welding current in order to induce the droplet of molten weld filler metal to pinch off from the distal end of the electrode;
lowering at least one of the welding current and the welding voltage after the short-circuit condition is no longer detected; and
moving the consumable wire electrode away from the cast iron component by a predetermined distance, thereby further assisting separation of the droplet of molten weld filler metal from the distal end of the electrode.

15. The method of claim 10, further including increasing at least one of the welding current and the welding voltage after the short-circuit condition is no longer detected and the electric-arc phase has been reestablished by ignition of an electric-arc between the distal end of the electrode and the cast iron component.

16. A method of low heat input weld repairing a cast iron component, the method comprising:
welding an area of the cast iron component using a Short-Circuit Gas Metal Arc Welding (GMAW-S) process, the GMAW-S process comprising:
providing electrical power from a power source to a consumable wire electrode, wherein the consumable wire electrode is made from one of a carbon steel alloy, a nickel alloy, or a nickel-iron alloy having a Coefficient of Thermal Expansion (CTE) that is within ±10% of the CTE of the cast iron material of the cast iron component, the electrical power being provided in a succession of pulses of electrical power with varying current and/or voltage;
reciprocating the consumable wire electrode toward and away from the cast iron component;
controlling the electrical power being provided to the electrode while the electrode is being reciprocated such that at least one of a welding current and a welding voltage supplied to the electrode is pulsed between a higher value and a lower value;
sensing a short-circuit condition when a molten droplet of weld filler metal on a distal end of the electrode makes contact with a molten weld pool being formed on a surface of the cast iron component;
moving the electrode away from the cast iron component and reducing the electrical power provided to the electrode each time the short-circuit condition is sensed; and
repeating the reciprocating of the electrode and the pulsing of electrical power provided to the electrode in order to deposit a succession of small droplets of molten weld filler metal from the electrode onto the surface of the cast iron component.

17. The method of claim 16, further including removing material from the area of the cast iron component before welding, and pre-heating the cast iron component before commencing the GMAW-S process to a temperature in a range from 200-800 degrees F.

18. The method of claim 16, further including pre-heating the cast iron component before commencing the GMAW-S process to a temperature in a range from 300-400 degrees F.

19. The method of claim 16, wherein the consumable wire electrode is reciprocated toward and away from the cast iron component at a cycle rate of between 50 and 150 cycles per second.

20. The method of claim 16, further including:
moving the consumable wire electrode toward the cast iron component while generating an electric-arc between the distal end of the electrode and the cast iron component by increasing at least one of the welding current and the welding voltage;
forming the droplet of molten weld filler metal on the distal end of the electrode;
detecting the short-circuit when the droplet on the distal end of the electrode contacts the molten weld pool on the cast iron component;
increasing the welding current in order to induce the droplet of molten weld filler metal to pinch off from the distal end of the electrode;
lowering at least one of the welding current and the welding voltage after the short-circuit condition is no longer detected; and
moving the consumable wire electrode away from the cast iron component by a predetermined distance, thereby further assisting separation of the droplet of molten weld filler metal from the distal end of the electrode.
